(19) United States
(12) Patent Application Publication
(10) Pub. No.: US 2021/0078400 A1
(43) Pub. Date: Mar. 18, 2021

(54) CLUTCH APPARATUS FOR HYBRID ELECTRIC VEHICLE

(71) Applicants: Hyundai Motor Company, Seoul (KR); Kia Motors Corporation, Seoul (KR)

(72) Inventors: Chulmin AHN, Anyang-si (KR); SungGon BYUN, Hwaseong-si (KR); Seok Joon KIM, Yongin-si (KR); Su Hyeon MAENG, Seoul (KR); Dong Hui CHEON, Hwaseong-si (KR); Baekyu KIM, Hwaseong-si (KR); Junyoung HA, Anyang-si (KR)

(73) Assignees: Hyundai Motor Company, Seoul (KR); Kia Motors Corporation, Seoul (KR)

(21) Appl. No.: 16/694,342

(22) Filed: Nov. 25, 2019

(30) Foreign Application Priority Data
Sep. 18, 2019 (KR) 10-2019-0114874

(51) Int. Cl. B60K 6/387; F16D 13/52; F16D 25/0638

(52) U.S. Cl. CPC B60K 6/387; B60Y 2200/92; F16D 25/0638; F16D 13/52

(57) ABSTRACT

According to an exemplary clutch apparatus of a hybrid electric vehicle, a clutch connection member directly transmits the torque of the motor to the input shaft, and a radially internal portion of a clutch connection member is spline-engaged with the input shaft while being supported by a step wall.

### CROSS-REFERENCE TO RELATED APPLICATION

The present application claims priority to Korean Patent Application No. 10-2019-0114874 filed on Sep. 18, 2019, the entire contents of which is incorporated herein for all purposes by this reference.

### BACKGROUND OF THE INVENTION

### Field of the Invention

The present invention relates to a clutch apparatus for a hybrid electric vehicle.

### Description of Related Art

Environment-friendly technology in vehicles is a core technology of a future vehicle industry, and automakers are focusing on developing environment-friendly vehicles to achieve environmental and fuel efficiency regulations.

An electric vehicle (EV) and a hybrid electric vehicle (HEV) that utilize electrical energy, and a double clutch transmission (DCT) improving efficiency and convenience may be examples of future vehicle technologies.

The hybrid electric vehicle is a vehicle using two or more power sources which may be combined in various schemes, and typically, a gasoline or diesel engine using fossil fuels and a motor/generator driven by electrical energy are combined to act as the power sources.

The dual-clutch transmission (DCT) alternatingly activates odd-numbered shifting stages and even-numbered shifting stages by alternatingly operating two clutches, and thereby improves continuity in torque transmission.

Recently, there has been a demand for a clutch apparatus of an HEV which may efficiently transmits torques of the engine and the motor to a transmission thereby improving a torque transmission efficiency, decreasing fuel consumption, and reducing an overall size and the number of employed parts.

Accordingly, there has been a demand for a clutch apparatus to efficiently operate the HEV, and the research and development for modularizing clutch apparatus and an engine clutch together with the motor of the hybrid electric vehicle has been continuously made.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a clutch apparatus of a hybrid electric vehicle for selectively connecting a torque of a motor and an engine to an input shaft of a transmission. The exemplary clutch apparatus may include a rotor hub, a hub connection member, a plurality of clutch plates, a clutch hub, a plurality of clutch disks, a clutch connection member, and a clutch piston unit. The rotor hub may be fixed to a rotor of the motor. The hub connection member may be fixed to an internal side of the rotor hub, forming an engagement end portion protrudingly formed in an axial direction from a radially innermost portion of the hub connection member, rotatably mounted on a damper output shaft through an internal circumference of the engagement end portion, and rotatably supported by a supporting end portion formed at a front case in an axial direction of the rotor hub through an external circumference of the engagement end portion interposing a bearing. The plurality of clutch plates may be spline-coupled with an internal circumference of the rotor hub. The clutch hub may be mounted at an internal side of internal circumference of the rotor hub and fixed to the damper output shaft,

The plurality of clutch disks may be alternatingly mounted between the plurality of clutch plates and spline-coupled with an external circumference of the clutch hub. An external circumferential end portion of the clutch connection member may be spline-coupled with the internal circumference of the rotor hub, and an internal circumferential end portion of the clutch connection member may be spline-coupled with the input shaft while being supported in the axial direction by a step wall formed at the input shaft. The clutch piston unit may be mounted between the clutch hub and the clutch connection member and forming a hydraulic pressure acting chamber together with the clutch connection member to control engagement of the plurality of clutch plates and the plurality of clutch disks.

The clutch piston unit may include, a clutch piston forming the hydraulic pressure acting chamber together with a sealing end portion and an internal circumferential end portion of the clutch connection member interposing a sealing, being movable in the axial direction thereof, and having a radially external end portion for selectively acting on the plurality of clutch plates, a spring retainer having an internal side supported by the internal circumferential end portion of the clutch connection member and a radially external side slidably connected to an extended end portion of the clutch piston, and a return spring mounted between the clutch piston and the spring retainer and providing a restoring force to the clutch piston.

The spring retainer may be supported in the axial direction by a snap ring mounted at the internal circumferential end portion of the clutch connection member.

The clutch connection member may form a step wall at the internal circumferential end, and the step wall may be rotatably supported by the damper output shaft interposing a bearing.

A support protrusion may be formed at the internal circumferential end portion of the clutch connection member to be supported by a step wall formed at the input shaft.

The hub connection member may be rotatably support by the damper output shaft interposing a bearing.

According an exemplary embodiment of the present invention, the radially internal portion of the clutch connection member for directly delivering the torque of the motor to the input shaft is spline-engaged with the input shaft IS while being abutted by the first step wall. As a result, number of support bearings mounted in the axial direction may be reduced or minimized, reducing an axial directional length and material cost of the transmission.

Furthermore, the hydraulic pressure acting chamber is formed between the clutch piston and the clutch connection member delivering the torque of the motor to the input shaft, minimizing the number of required portions and an installation space.

Furthermore, according to an exemplary embodiment of the present invention, the rotor hub of the motor functions as a clutch drum while being rotatably supported by a front case via a bearing, and thereby space efficiency may be increased while removing a necessity for a separate clutch drum.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an exemplary clutch apparatus of a hybrid electric vehicle.

FIG. 2 is an enlarged view of a principal portion of an exemplary clutch apparatus of a hybrid electric vehicle.

FIG. 3 illustrates torque transmission of an exemplary clutch apparatus of a hybrid electric vehicle.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other h, and the present invention(s) is/are intended to cover not only the exemplary embodiments of the present invention, but also various alternatives, modifications, equivalents and other embodiments, which may be included within the spirit and scope of the present invention as defined by the appended claims.

An exemplary embodiment of the present invention will hereinafter be described in detail with reference to the accompanying drawings.

The drawings and description are to be regarded as illustrative in nature and not restrictive, and like reference numerals designate like elements throughout the specification.

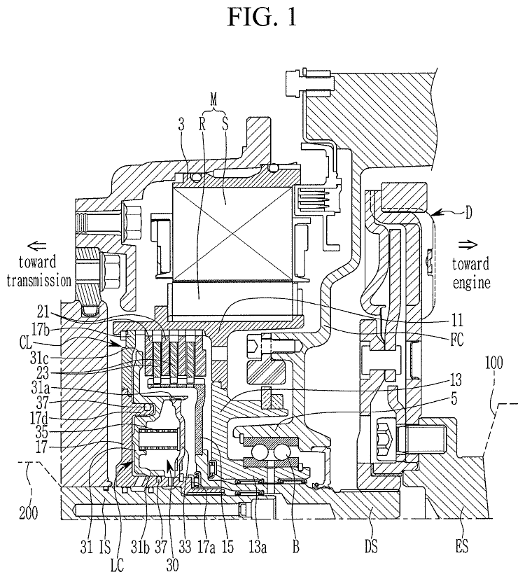

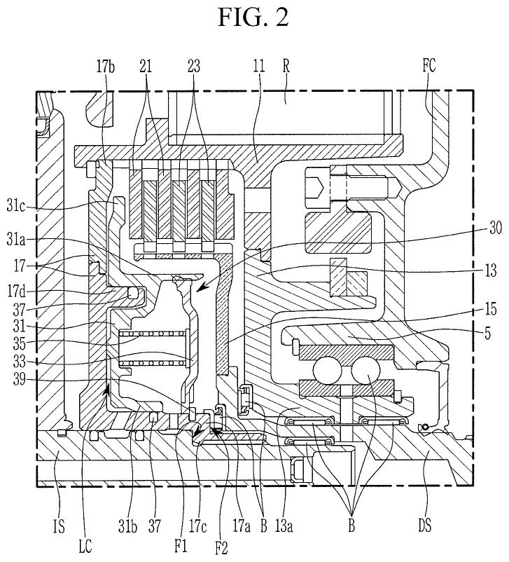

FIG. 1 is a cross-sectional view of an exemplary clutch apparatus of a hybrid electric vehicle, and FIG. 2 is an enlarged view of a principal portion of an exemplary clutch apparatus of a hybrid electric vehicle.

Referring to FIG. 1 and FIG. 2, a clutch apparatus CL for a hybrid electric vehicle according to an exemplary embodiment of the present invention receives a torque of a motor M, and also a torque of an engine 100 through a damper output shaft DS connected to an engine output shaft ES of the engine 100, for example, interposing a damper D. The clutch apparatus CL is selectively connectable to an input shaft IS of a shifting device (e.g., a transmission) 200 to selectively transmit a torque.

The motor M includes a rotor R and a stator S and may act as a motor and a generator, as in an electric vehicle.

The rotor R is rotatably supported by a supporting end portion 5 formed at a radially internal side of a front case FC interposing a rotor hub 11 and a hub connection member 13. The stator S is fixed to the front case FC interposing a support ring 3.

An exemplary clutch apparatus CL includes the rotor hub 11, the hub connection member 13, a plurality of clutch plates 21, a clutch hub 15, a plurality of clutch disks 23, a clutch connection member 17, and a clutch piston unit 30.

In an exemplary clutch apparatus CL, the torque of the motor M is always transmitted to the input shaft IS, and the torque of the engine 100 is selectively transmitted to the input shaft IS.

An exemplary clutch apparatus CL is hereinafter described in further detail with reference to the drawings.

The rotor hub 11 is fixed to the rotor R of the motor M.

The hub connection member 13 is fixed to a radially internal side of the rotor hub 11, and is formed with an engagement end portion 13a protruding from a radially innermost portion of the hub connection member, in an axial direction thereof, e.g., toward an engine side thereof.

The hub connection member 13 is rotatably mounted on the damper output shaft DS interposing a bearing B between the damper output shaft DS and an internal circumference of the engagement end portion 13a. An external circumference of the engagement end portion 13a is rotatably supported by the front case FC interposing a bearing B between the engagement end portion 13a and a supporting end portion 5 protruding from the front case FC in an axial direction thereof, e.g., toward a transmission side thereof.

An external circumferential end portion of the hub connection member 13 is fixed to the radially internal side of the rotor hub 11, e.g., by welding. The hub connection member 13, in more detail, the engagement end portion 13a, is rotatably supported by the damper output shaft DS interposing the bearing B.

The plurality of clutch plates 21 are spline-engaged with an internal circumference of the rotor hub 11.

The clutch hub 15 is mounted at a radially internal side of the rotor hub 11 facing the internal circumference of the rotor hub 11. A radially internal side of the clutch hub 15 is fixed to an end portion of the damper output shaft DS, e.g., by welding.

The plurality of clutch disks 23 are alternatingly mounted between the plurality of clutch plates 21, and are spline-engaged with an external circumference of the clutch hub 15.

The clutch connection member 17 may formed by welding two members, and may be formed with an external circumferential end portion 17b spline-engaged with an internal circumference of the rotor hub 11.

The clutch connection member 17 includes an internal circumferential end portion 17a protruding in the axial direction thereof, e.g., toward the engine side thereof. An internal circumference of the internal circumferential end portion 17a is spline-engaged with the input shaft IS while being supported in the axial direction thereof, by a first step wall F1 formed at the input shaft IS.

The internal circumferential end portion 17a protruding from the clutch connection member 17 forms a second step wall F2, and the second step wall F2 is rotatably supported by the damper output shaft DS interposing a bearing B.

Furthermore, the internal circumferential end portion 17a of the clutch connection member 17 forms a support protrusion 17c which is supported by the first step wall F1 of the input shaft IS.

The clutch piston unit 30 is mounted between the clutch hub 15 and the clutch connection member 17. The clutch piston unit 30 forms a hydraulic pressure acting chamber LC with the clutch connection member 17 to selectively force the clutch plates 21 and the clutch disks 23 to interact with each other.

The clutch piston unit 30 includes a clutch piston 31, a spring retainer 33, and a return spring 35.

The clutch piston 31 forms the hydraulic pressure acting chamber LC as closed and sealed by interposing a sealing 37 respectively with a sealing end portion 17d and the internal circumferential end portion 17a of the clutch connection member 17. The clutch piston 31 may move in the axial direction thereof, e.g., to the right in the drawing, i.e., toward the engine side, by the hydraulic pressure supplied to the hydraulic pressure acting chamber LC. A radially external end portion 31c of the clutch piston 31 is formed to apply pressure to the clutch plates 21.

A radially internal end portion of the spring retainer 33 is slidable along the internal circumferential end portion 17a of the clutch connection member 17 and an extended end portion 31a formed at the clutch piston 31.

The radially internal end portion of the spring retainer 33 is supported in the axial direction by a snap ring 39 mounted at the internal circumferential end portion 17a of the clutch connection member 17.

The return spring 35 is mounted between the clutch piston 31 and the spring retainer 33 to provide a restoring force to the clutch piston 31, e.g., to the left in the drawing, i.e., toward the transmission side thereof.

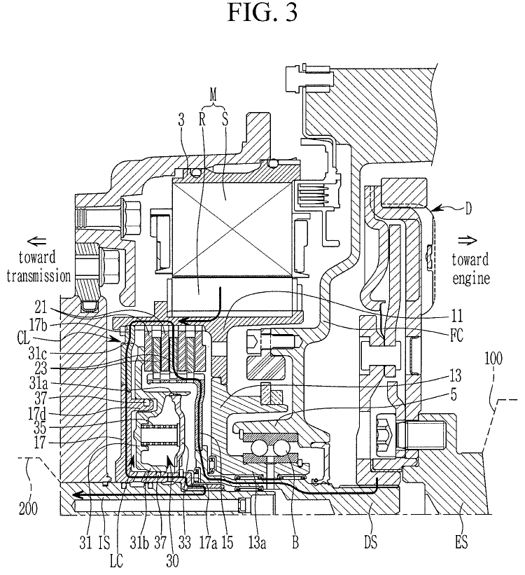

FIG. 3 illustrates torque transmission of an exemplary clutch apparatus of a hybrid electric vehicle.

Operation of an exemplary clutch apparatus CL is hereinafter described in detail with reference to FIG. 3

Referring to FIG. 3, the clutch apparatus CL is operated when the clutch piston 31 is moved to the right in the drawing, e.g., by a hydraulic pressure supplied to the hydraulic pressure acting chamber LC, to engage the clutch plates 21 and the clutch disks 23. When the clutch apparatus CL is operated, the torque of the engine 100 is consecutively transmitted through the damper output shaft DS, the clutch hub 15, the friction members (i.e., the clutch plates and the clutch disks) 21 and 23, the rotor hub 11, the clutch connection member 17, and the input shaft IS.

In an HEV mode, the motor M is driven to provide an auxiliary torque to the HEV.

In an EV mode where the engine is stopped and the vehicle is driven only by the torque of the motor M, the operation of the clutch apparatus CL is released, and the torque of the motor M is always transmitted from the rotor R to the input shaft S consecutively through the rotor hub 11 and the clutch connection member 17, regardless of whether the clutch apparatus CL is operated or not.

According to a clutch apparatus of a hybrid electric vehicle according to an exemplary embodiment of the present invention, the radially internal portion of the clutch connection member 17 for directly delivering the torque of the motor M to the input shaft IS is spline-engaged with the input shaft IS while being abutted by the first step wall F1. Therefore, a reaction force from the cultch piston 31 and the return spring 35 of the clutch piston unit 30 may be abutted by a simple structural feature.

As a result, number of support bearings mounted in the axial direction may be reduced or minimized, reducing an axial directional length and material cost of the transmission.

Furthermore, the hydraulic pressure acting chamber LC is formed between the clutch piston 31 and the clutch connection member 17 delivering the torque of the motor M to the input shaft IS, minimizing the number of required portions and an installation space.

Furthermore, according to an exemplary clutch apparatus CL, the rotor hub 11 of the motor M functions as a clutch drum while being rotatably supported by a front case FC via a bearing B, and thereby space efficiency may be increased while removing a necessity for a separate clutch drum.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A clutch apparatus for a hybrid electric vehicle for selectively connecting a torque of a motor and an engine to an input shaft of a transmission, the clutch apparatus comprising:
a rotor hub fixed to a rotor of the motor;
a hub connection member fixed to an internal side of the rotor hub, wherein the hub connection member includes an engagement end portion protrudingly formed in an axial direction of the rotor hub from a radially innermost portion of the hub connection member, rotatably mounted on a damper output shaft through an internal circumference of the engagement end portion, and rotatably supported by a supporting end portion formed at a front case in the axial direction through an external circumference of the engagement end portion;
a plurality of clutch plates spline-coupled with an internal circumference of the rotor hub;
a clutch hub mounted at an internal side portion of the internal circumference of the rotor hub and fixed to the damper output shaft;
a plurality of clutch disks alternatingly mounted between the plurality of clutch plates and spline-coupled with an external circumference of the clutch hub;
a clutch connection member, an external circumferential end portion of which is spline-coupled with the internal circumference of the rotor hub, and an internal circumferential end portion of which is spline-coupled with the input shaft while being supported in the axial direction by a first step wall formed at the input shaft; and
a clutch piston unit mounted between the clutch hub and the clutch connection member and forming a hydraulic pressure acting chamber with the clutch connection member to control engagement of the plurality of clutch plates and the plurality of clutch disks.

2. The clutch apparatus of claim 1, wherein a bearing is mounted between the damper output shaft and the engagement end portion.

3. The clutch apparatus of claim 1, wherein the clutch piston unit includes:
a clutch piston forming the hydraulic pressure acting chamber with a sealing end portion and the internal circumferential end portion of the clutch connection member being movable in the axial direction, and having a radially external end portion for selectively acting on the plurality of clutch plates;
a retainer having an internal side portion supported by the internal circumferential end portion of the clutch connection member and an external side portion slidably connected to an extended end portion of the clutch piston; and
an elastic member mounted between the clutch piston and the retainer and providing a restoring force to the clutch piston.

4. The clutch apparatus of claim 3, wherein a first sealing is mounted between the clutch piston and the sealing end portion of the clutch connection member.

5. The clutch apparatus of claim 3, wherein a second sealing is mounted between the clutch piston and the internal circumferential end portion of the clutch connection member.

6. The clutch apparatus of claim 3, wherein the retainer is supported in the axial direction by a snap ring mounted at the internal circumferential end portion of the clutch connection member.

7. The clutch apparatus of claim 1,
wherein the clutch connection member includes a second step wall at the internal circumferential end portion; and
wherein a bearing is mounted between the second step wall and the damper output shaft and the second step wall is rotatably supported by the damper output shaft via the bearing.

8. The clutch apparatus of claim 1, wherein a support protrusion is formed at the internal circumferential end portion of the clutch connection member to be supported by the first step wall formed at the input shaft.

9. The clutch apparatus of claim 1, wherein a bearing is disposed between the hub connection member and the damper output shaft and the hub connection member is rotatably support by the damper output shaft via the bearing.

10. A clutch apparatus for a hybrid electric vehicle for selectively connecting a torque of a motor and an engine to an input shaft of a transmission, the clutch apparatus comprising:
a hub connection member fixed to an internal side of a rotor hub of the motor and rotatably mounted on a damper output shaft;
a plurality of clutch plates spline-coupled with an internal circumference of the rotor hub;
a clutch hub mounted at an internal side of the rotor hub and having an internal side portion fixed to the damper output shaft;
a plurality of clutch disks alternatingly mounted between the plurality of clutch plates and spline-coupled with an external circumference of the clutch hub;
a clutch connection member, an external circumferential end portion of which is spline-coupled with the internal circumference of the rotor hub, and an internal circumferential end portion of which is spline-coupled with the input shaft and is formed with a support protrusion supported in an axial direction of the rotor hub by a first step wall formed at the input shaft; and
a clutch piston unit mounted between the clutch hub and the clutch connection member and forming a hydraulic pressure acting chamber with the clutch connection member to control engagement of the plurality of clutch plates and the plurality of clutch disks.

11. The clutch apparatus of claim 10, wherein the hub connection member is rotatably mounted on the damper output shaft through an internal circumference of an engagement end portion protrudingly formed in the axial direction from a radially innermost portion of the hub connection member, and is rotatably supported by a supporting end portion formed at a front case through an external circumference of the engagement end portion, a bearing mounted between the supporting end portion and the external circumference of the engagement end portion.

12. The clutch apparatus of claim 10, wherein a bearing is mounted between the hub connection member and the damper output shaft and the hub connection member is rotatably supported by the damper output shaft via the bearing.

13. The clutch apparatus of claim 10, wherein the clutch piston unit includes:
a clutch piston forming the hydraulic pressure acting chamber with a sealing end portion and the internal circumferential end portion of the clutch connection member, being movable in the axial direction, and having a radially external end portion for selectively acting on the plurality of clutch plates;
a retainer having an internal side portion supported by the internal circumferential end portion of the clutch connection member and an external side portion slidably connected to an extended end portion of the clutch piston; and
an elastic member mounted between the clutch piston and the retainer and providing a restoring force to the clutch piston.

14. The clutch apparatus of claim 13, wherein a first sealing is mounted between the clutch piston and the sealing end portion of the clutch connection member.

15. The clutch apparatus of claim 13, wherein a second sealing is mounted between the clutch piston and the internal circumferential end portion of the clutch connection member.

16. The clutch apparatus of claim 13, wherein the retainer is supported in the axial direction by a snap ring mounted at the internal circumferential end portion of the clutch connection member.

17. The clutch apparatus of claim 10,
wherein the clutch connection member forms a second step wall at the internal circumferential end portion; and
wherein a bearing is mounted between the second step wall and the damper output shaft and the second step wall is rotatably supported by the damper output shaft via the bearing.
